(19) United States
(12) Patent Application Publication
(10) Pub. No.: US 2010/0300050 A1
(43) Pub. Date: Dec. 2, 2010

(54) Articulated Stirrup

(76) Inventors: Valentin Völlmecke, Iserlohn (DE); Heinz Baumann, Iserlohn (DE); Brigitte Schulte, Iserlohn (DE)

Correspondence Address: John Lezdey And Associates, 2401 West Bay Drive, Suite 118, Largo, FL, 33770, US

(21) Appl. No.: 12/225,214

(22) PCT Filed: Mar. 7, 2007
(86) PCT No.: PCT/EP2007/052150

§ 371 Date: Sep. 16, 2008

(30) Foreign Application Priority Data
Mar. 17, 2006 (DE) 10 2006 012 704.8
Jun. 10, 2006 (DE) 10 2006 048 088.0

(51) Int. Cl. B68C 3/00

(52) U.S. Cl. 54/47

(57) ABSTRACT

The invention relates to an articulated stirrup with a footplate and a U-shaped clamp with two lateral limbs and articulated regions arranged therein. The articulated regions have an upper retaining part and a lower retaining part with a hinge part. The lower retaining part reaches the footplate. The footplate has a supporting part which connects the lower retaining parts to each other.

The invention relates to an articulated stirrup with a footplate and with a U-shaped clamp which has side arms and joints arranged therein, said joints comprising an upper retaining part, a lower retaining part and a hinge part, e.g., a piece of a bicycle chain, arranged between said two retaining parts.

On this articulated stirrup previously known from European Patent 1 903 688 B1, which is also referred to as a safety stirrup, the articulated regions are disposed somewhat above the footplate in the lower part of the side arms and are covered by a hose. A normal one-piece metal stirrup is used to make this articulated stirrup. The side arms are cut through in their lower region. At each cutting point, an upper retaining part or a lower retaining part is formed by specially machining the cut end regions for them to receive a hinge part. A piece of a bicycle or motorbike chain is preferably provided as a hinge part.

A stirrup which is substantially made from plastic material is known from DE 2 125 332 A1, this stirrup however is no articulated stirrup. In the clamp and in the footplate there is embedded a continuous armoring element in the form of steel wires.

In the articulated stirrup according to U.S. Pat. No. 6,766,632 B2, the hinge parts are formed by wire portions that are respectively retained in the upper and in the lower retaining part. An articulated stirrup of similar build has also become known by Royal Rider, 42015 Correggion (RE) Italy, see also www.royal-rider.com under the designation: Jump 25 Flex. On this latter articulated stirrup, the footplate has a body made from plastic and the lower retaining parts have flutes and are shape-matingly embedded in the plastic body. Like in DE 21 25 332 A1, the surface is not made from metal, it is formed from plastic material and at need from rubber sleeves which respectively cover the hinge parts.

On the previously known articulated stirrup of the type mentioned herein above, the footplate is extremely solid but suffers from the disadvantage of being quite heavy. It substantially determines the overall weight of the articulated stirrup.

However, it has been found efficient to form the clamp from metal, more specifically from stainless steel, which makes the stirrup very robust.

In view of the stirrup of the type mentioned herein above, it is the object of the invention to develop the footplate so that it has less overall weight than hereto before on the one side and so that, on the other side, the reliability does not suffer from the lighter build, meaning that comparable safety is obtained with the metallic articulated stirrup.

In view of the articulated stirrup of the type mentioned herein above, this object is achieved in that the articulated stirrup comprises a footplate and a U-shaped clamp having side arms and articulated regions arranged therein, said articulated regions comprising an upper retaining part, a lower retaining part and a hinge part, e.g., a piece of a bicycle chain, arranged between these two retaining parts.

On this articulated stirrup, the footplate is significantly lighter than hitherto in the case of a metallic prior art implementation. The static and dynamic demands are met through the carrier part and through the lower retaining parts and by the fact that the carrier part is connected at either end to the lower retaining parts. As a result, the body made from plastic material must meet almost no static and dynamic demand; it substantially dictates the outer shape and the described parts are embedded therein. Thanks to this embedded position, the body made from plastic fixes the carrier part and the lower retaining parts. Preferably, these are not only connected by the fact that they are enveloped by the plastic body, but are sufficiently connected for the function of the footplate to be preserved is the body made from plastic comes to fail. On the stirrup of the invention, the center of gravity can be positioned at a distance from the footplate that is greater than in prior art on the one side and also, on the other side, it can be positioned more specifically.

The carrier part is preferably made from a material having tensile strength. As a result, it is made certain that it is capable of taking the loads occurring in practical operation, even if the body made from plastic is missing.

As the carrier part is enveloped, it is protected. Accordingly, materials can for example be used, which are prone to corrosion or which could separate.

The cooperation of the plastic body and the structure-giving parts, meaning lower retaining parts and carrier part, make it possible to achieve the best possible solidity, a favorable weight and can ideally adjust to the respective demands.

Preferably, the carrier part is permanently connected to the lower retaining parts; the connection is such that it remains safe even if the plastic body is missing or destroyed.

In an advantageous developed implementation, the carrier part has cutouts for the plastic material to penetrate during the manufacturing of the plastic body by casting. As a result, an intimate connection is achieved between the structure-giving parts and the plastic body.

The plastic body is preferably applied by casting upon the already made, structure-forming parts, a die casting process being preferably utilized.

In a particularly preferred implementation, the carrier part is connected integrally with the lower retaining parts. As a result, it is made certain that the best possible solidity is achieved. Any junctures that could fail in operation are absent.

Other features and advantages will become more apparent upon reviewing the appended claims and the following non restrictive description of eight embodiments of the invention, given by way of example only with reference to the drawing. In said drawing:

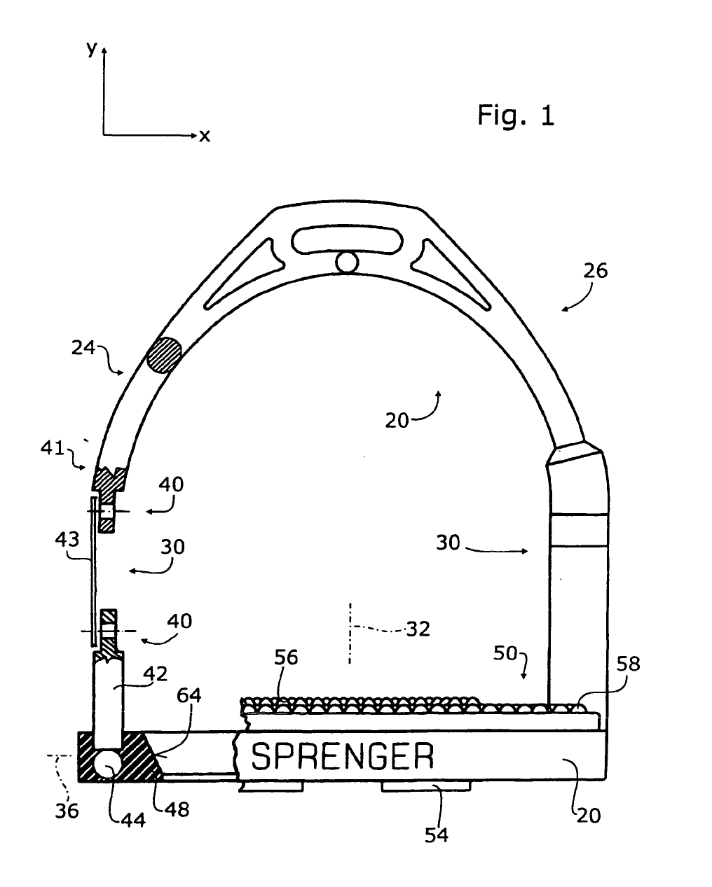

FIG. 1: is a front view of the articulated stirrup, illustrated in partial section view to show the detail of the articulated regions,

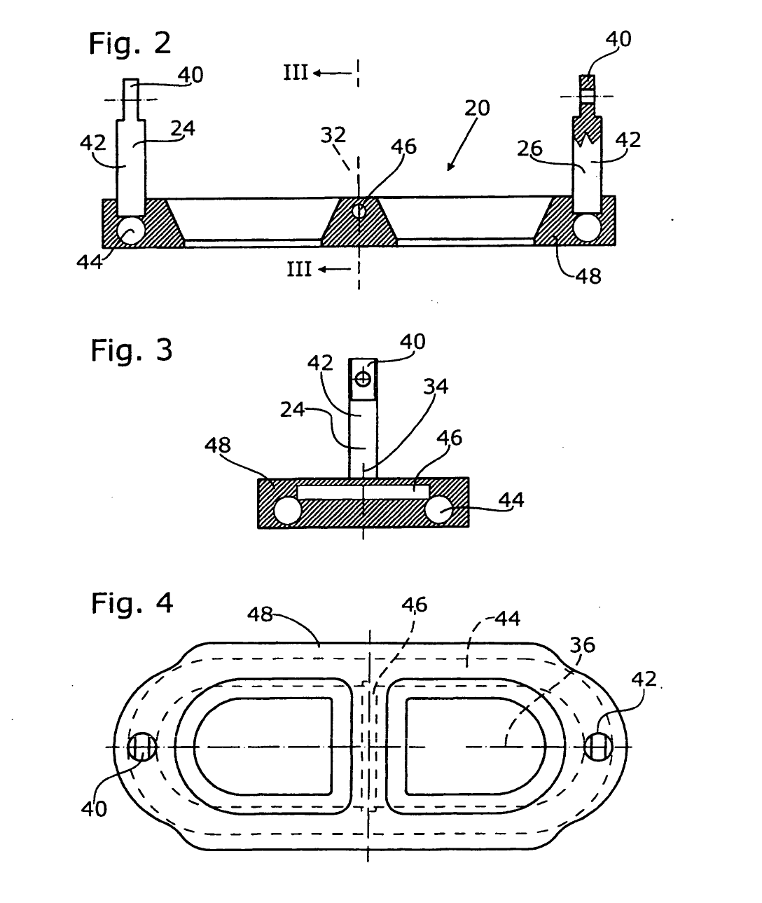

FIG. 2: is a section view of the footplate without rubber insert, the section plane is the x-y plane (longitudinal plane),

FIG. 3: is a section taken along the section line in FIG. 2,

FIG. 4: is a top view in the negative y direction of the footplate shown in FIG. 2 and also without rubber insert,

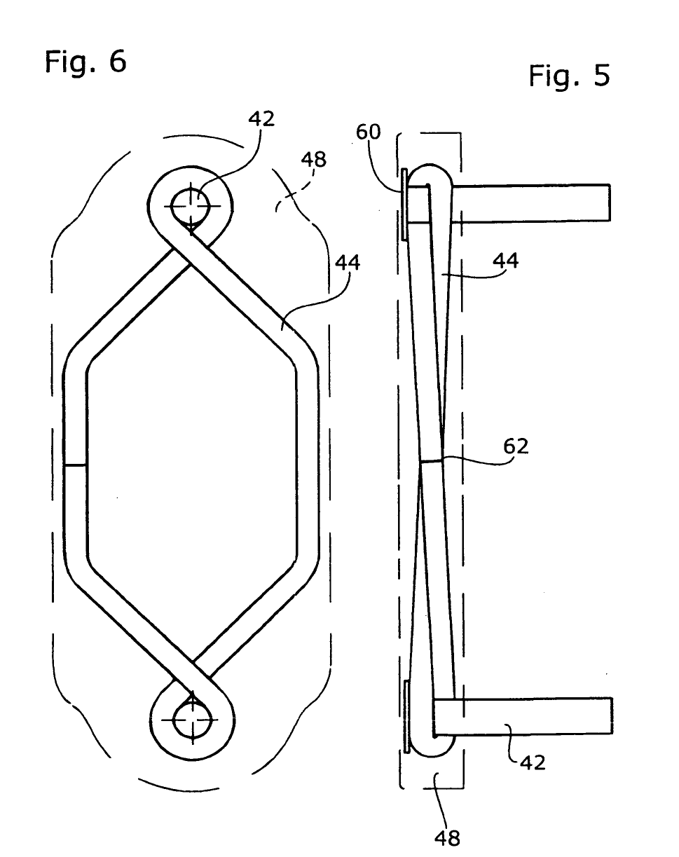

FIG. 5: is a side view in the z direction of the structure-giving parts of a footplate with the plastic body being shown in a dashed line,

FIG. 6: is a top view in the negative y direction of the footplate shown in FIG. 5,

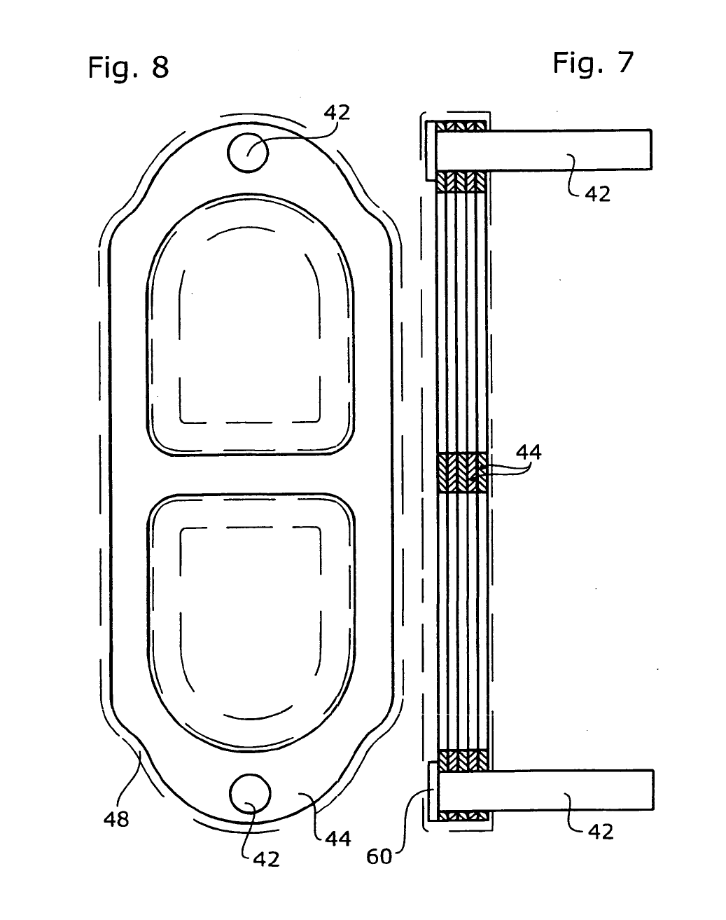

FIG. 7: is an illustration similar to FIG. 5 for a third exemplary embodiment of the footplate,

FIG. 8: is a view like FIG. 6 of the implementation shown in FIG. 7,

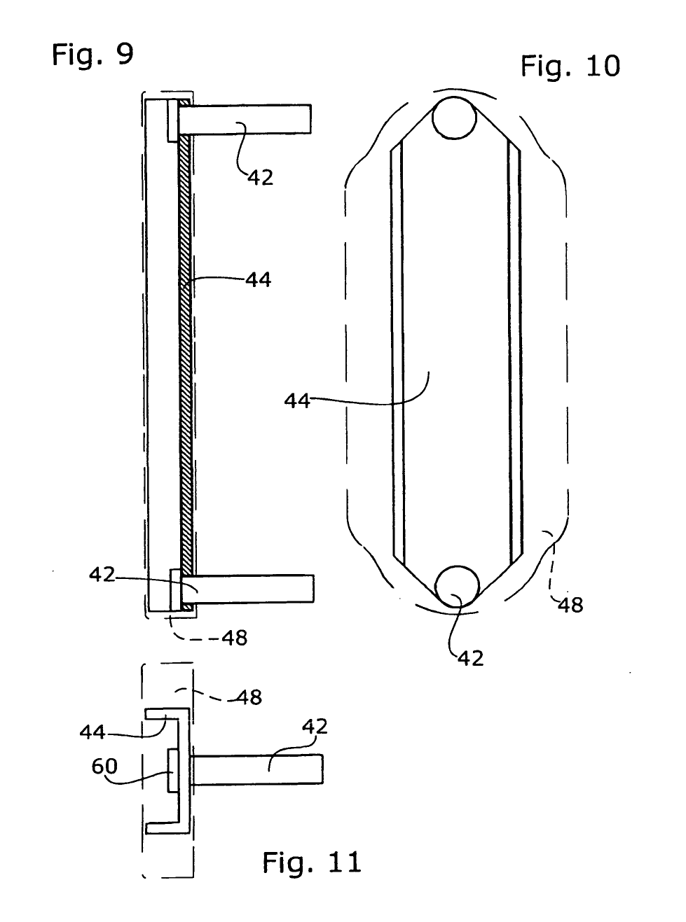

FIG. 9: is an illustration like FIG. 5 for a fourth exemplary embodiment of the footplate,

FIG. 10: is an illustration according to FIG. 6 for the fourth implementation according to FIG. 9,

FIG. 11: is an end view of the fourth exemplary embodiment, viewed in the x direction,

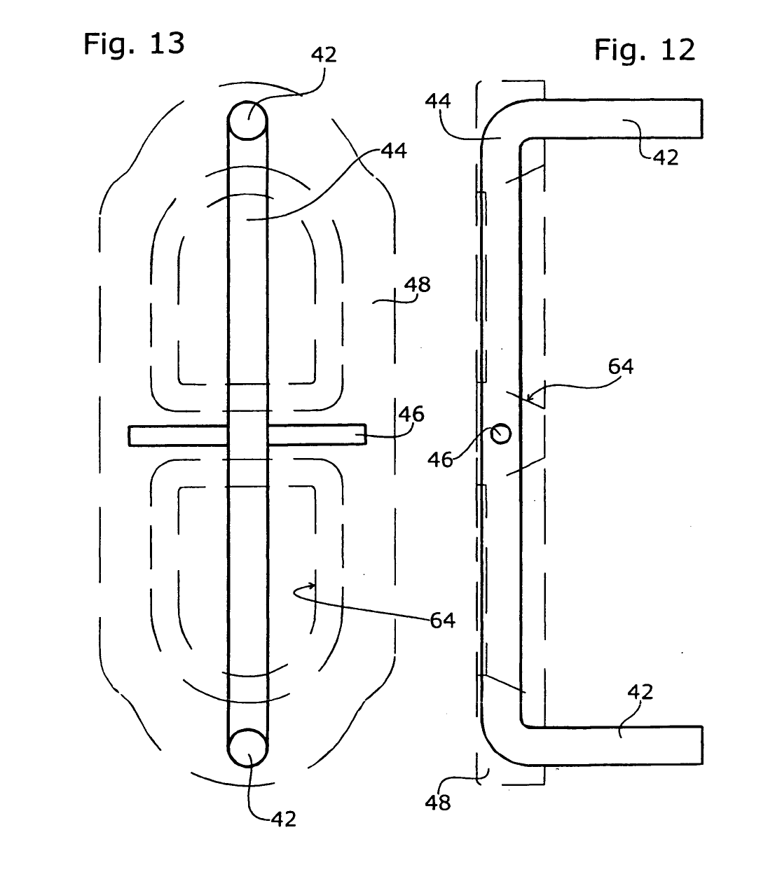

FIG. 12: is an illustration like FIG. 5 for a fifth exemplary embodiment of the footplate,

FIG. 13: is an illustration like FIG. 6 for the fifth implementation according to FIG. 12,

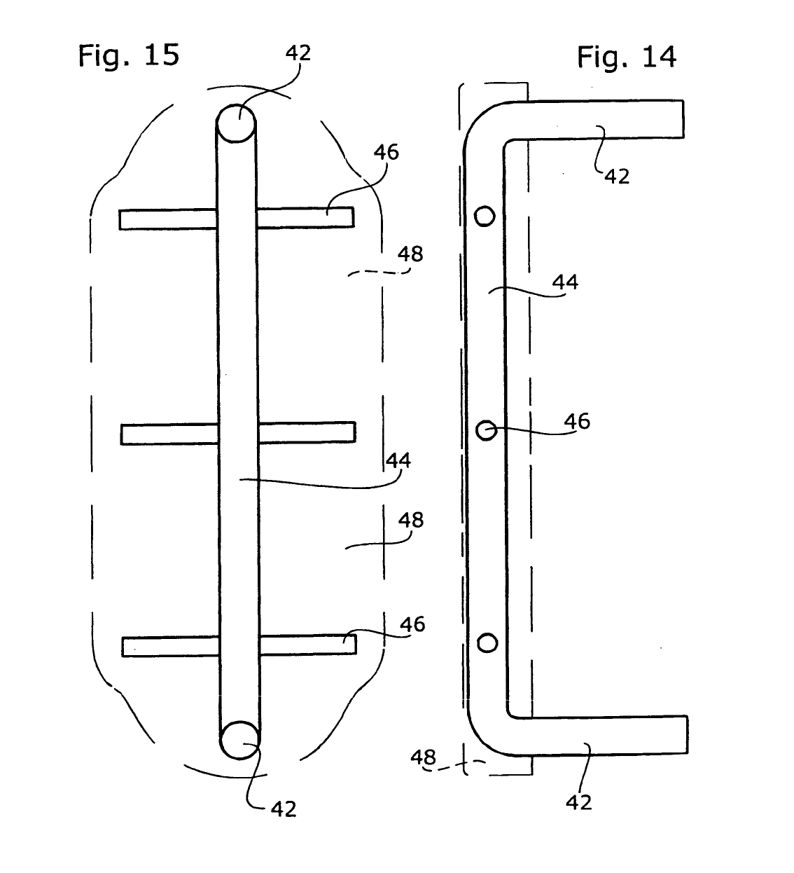

FIG. 14: is an illustration like FIG. 5 for a sixth exemplary embodiment,

FIG. 15: is an illustration like FIG. 6 for the sixth exemplary embodiment according to FIG. 14,

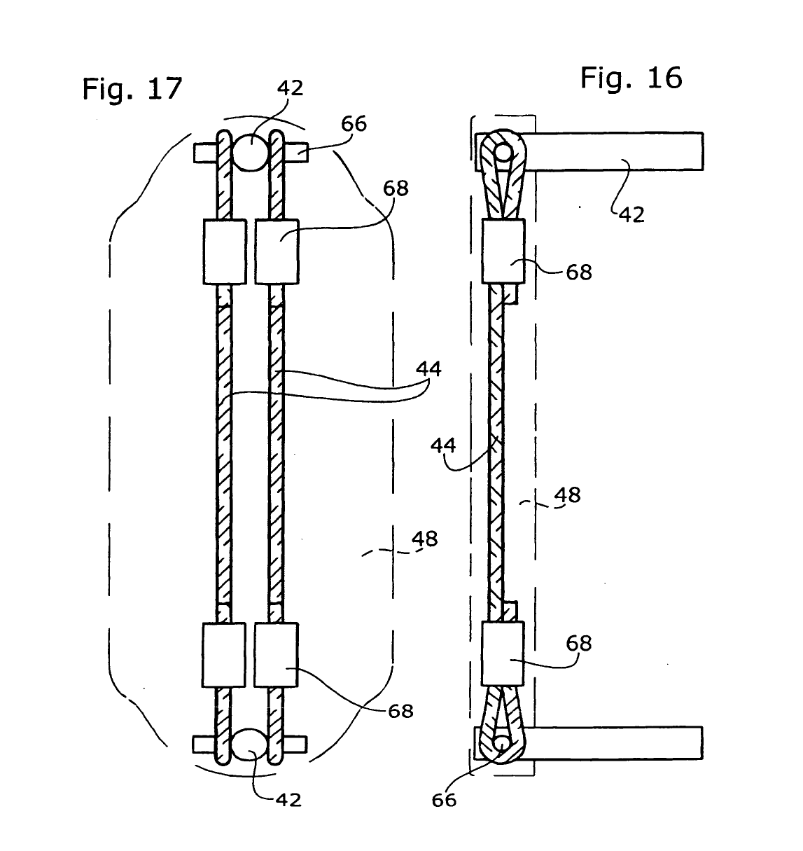

FIG. 16: is an illustration like FIG. 5 for a seventh implementation of the footplate, and

FIG. 17: is an illustration like FIG. 6 for the seventh implementation according to FIG. 16.

A stirrup as comprehensively shown in FIG. 1 and, in addition thereto, in parts in the other Figs., has a footplate 20 that forms a surface on which to support a boot that has not been illustrated herein, and a U-shape clamp 22 connected to said footplate 20. This clamp 22 comprises two lateral limbs 24. 26. The two limbs 24, 26 are provided with an articulated region 30 in their lower region. The reader is referred to the already mentioned European Patent 1 003 688 B1, more specifically to the three Figs. of this patent document with respect to the configuration of the articulated region 30.

The stirrup has rotational symmetry with respect to a mean perpendicular 32 of the footplate 20, the symmetry is 180°. This mean perpendicular 32 lies in a longitudinal plane 34. The longitudinal plane 34 is further defined by a longitudinal axis 36 of the footplate 20 which joins the center of the base points of the two limbs 24, 26. At the same time, the longitudinal plane 34 is a symmetry plane for the footplate 20. In FIG. 1, the longitudinal plane 34 extends in the plane of the paper.

In FIG. 1, the axes x, y of a rectangular coordinate system are drawn for a better understanding of the stirrup, the z axis is not shown, it extends at right angles from the plane of the paper. The longitudinal plane 34 lies in the x-y plane. It extends centrally through the stirrup. A transverse plane 38 extends in the y-z plane. It is to be noted that, as contrasted to the drawing, the center of this coordinate system lies in the center of the footplate 20, meaning at the intersection of longitudinal axis 36 and mean perpendicular 32. The longitudinal axis 36 lies on the x axis. The mean perpendicular 32 lies on the y axis.

In FIG. 1, there is shown an upper portion of the U-shaped clamp 22. This portion ends as shown from the left section, in a connecting region 40 as it is known from EP 1 003 688 B1. Holes are visible in the connecting regions 40. They define one of the several hinge axes of the articulated region 30, which are parallel to each other. This connecting region 40 of the upper portion is also referred to as the upper retaining part 41. Opposite thereto, there is a connecting region 40 of a lower portion of the clamp 22, which is referred to as the lower retaining part 42. Between these retaining parts 41, 42, there is a hinge part 43 that is only outlined herein; for disclosure the reader is referred to the European Patent mentioned. As shown in the Figs. for all the exemplary embodiments, the lower retaining parts 42 extend, at least some millimetres, e.g., at least three, preferably at least five millimetres, into the footplate 20 where they are surrounded by the plastic material or embedded therein.

According to the first exemplary embodiment, FIG. 1 through 4, the footplate 20 is built as follows: it has a carrier part 44 made from a round material. The diameter of the round material corresponds to the diameter of the limbs 24, 26 in their lowermost part, as shown for example in the FIGS. 2 and 4. The carrier part 44 is curved into an oval shape, precisely, it consists of two half circles and of rectilinear portions for connecting said half circles. In the apex of a respective one of the semi-circular regions it is connected to lower end pieces of the limbs 24, 26, meaning with the lower retaining parts 42. The connection can be through welding, screwing or the like. Additionally, the carrier part 44 has a cross member 46 that joins the rectilinear portions together in their center. It is made from a thinner round material, for example with 30-50% of the diameter of the material of the carrier part 44. It is placed on top of the cross member 46 and is welded thereto at its ends.

Plastic material is molded around carrier part 44 and cross member 46 as well as around the lowermost end regions of the lower portions of the limbs 24, 26 so that a plastic body having approximately the shape of the FIG. 8 is formed. This shape can be seen from the FIGS. 2, 4, 8, 13 and so on. This construction allows weight saving. At the same time, the connecting points are protected. The plastic body 48 has a level top side and a level underside, both are parallel to the x-z plane.

In an actually known manner, a rubber insert 50 is clipped into the thus formed footplate 20; it is shown in parts in FIG. 1. It is formed from a suited elastomer material. It forms an integral upper rest region 52 and adjoining arms with projections 54, said projections engaging underneath the underside of the footplate 20 and securing the rubber insert 50 into place. The rubber insert 50 extends through two recesses 64 of the footplate 20 which are in a U shape and are mirror symmetrical with respect to the y-z plane, see first, third and fifth exemplary embodiment. In the other exemplary embodiments, no recess 64 is shown.

In a variant to the implementation shown in the FIGS. 2 through 4, it is also possible not to place the limbs 24, 26 with their lower ends butt-jointed onto the carrier part 44 and to connect them thereto, but to configure both parts to be integral, at least partially. For this purpose, the limb 24, 26 can be configured to be longer in the bottom part and can be angled 90° in the plane of the carrier part 44 so as to form at least a portion of the carrier part 44. For this purpose, the reader is referred to the fifth implementation shown in the FIGS. 12 and 13 and to the sixth implementation shown in the FIGS. 14 and 15.

In the second exemplary embodiment shown in the FIGS. 5 and 6, the carrier part 44 is made from a round material, for example from metal or from plastic material. It has an imposed shape into which it is curved. This shape consists of an approximately hexagonal central region and of two enlacements in opposite corners. The carrier part 44 is made from one piece. At the enlacements, the carrier part 44 forms an almost completely surrounding grip around the two lower retaining parts 42. A disk 60 adjoins the bottom part of the lower retaining parts 42 and is connected to the lower retaining part 42. It secures the carrier part 44 downward. The round material from which the carrier part 44 is made is joined together at a connecting point 62, such as by gluing, welding or soldering.

In the third implementation shown in the FIGS. 7 and 8, the carrier part 44 is formed from several, five are shown, identically built, flat parts approximately shaped like the FIG. 8 or blanks that are threaded onto the two lower retaining parts 42. For this purpose, each blank has holes that are adapted to the diameter of the lower retaining part 42. Moreover, the blanks each have two cutouts for the recesses 64. The blanks, which together form the carrier part 44, can be provided in any number so that the weight can be selected. They are stacked. In this way, the weight may be varied from a high weight and hence from high strength, to lower weight. The center of gravity of the entire stirrup can thus be set in one region.

In the fourth implementation shown in the FIGS. 9 through 11, the carrier part 44 is again made from metal or plastic material, like in the previous exemplary embodiment, this time it has a U-shaped cross section, see FIG. 11. As a result, high strength is achieved in the direction of the load, meaning in the negative y direction. Again, the lower retaining parts 42 are terminated by a disk 60 that is solidly connected thereto. As a result, the carrier part 44 can simply rest thereon, but can also be solidly connected to the lower retaining parts 42 and/or to the disk 60.

In the fifth implementation shown in the FIGS. 12 and 13, the carrier part 44 is configured integral with the two lower retaining parts 42, a corresponding U-shaped part is shown in FIG. 12. This implementation offers the advantage of low weight and of high reliability. To additionally reinforce the plastic body 48, there is still provided a cross member 46 which can also be provided several times, as shown in the following exemplary embodiment, but which may also be absent. In order to avoid that the carrier part 44 passes through the recesses 64, the carrier part 44 can also be bent about these recesses 64. What matters is that it is configured integral with the lower retaining parts 42.

The sixth exemplary embodiment shown in the FIGS. 14 through 16 substantially corresponds to the fifth exemplary embodiment; now three cross parts 46 in all are provided. As shown, they can each be welded on the side, be passed through holes of the round material of the carrier part 44 or rest on top of it and be connected therewith.

The seventh exemplary embodiment shown in the FIGS. 16 and 17 finally shows a carrier part 44 in the form of two parallel ropes made for example from metal or from plastic. At their ends the ropes have eyes which are formed by bringing the material back and assembling it into a sleeve 68. The eyes are plugged onto the cross pins 66 for a shape-mating bond to be achieved. As shown, it is possible to work with two rope portions although one rope portion is enough.

In all the exemplary embodiments shown, the two lower retaining parts 42 project from the plastic body 48. In most of the exemplary embodiments, carrier parts 44 and a possibly provided cross member 46 are completely embedded in the material of the plastic body 48. Only the fifth exemplary embodiment constitutes an exception in which portions of the carrier part 44 are visible inside the recesses 64. These portions do not hinder insertion of the rubber insert 50 but support it toward the bottom instead. The projections 54 engage into the gaps between the carrier part 44 and the lateral borders of the recesses 64. The carrier part 44 is also referred to as a bridge part. It is preferably roughened on its surface or otherwise provided with recesses which allow for a good connection with the plastic of the body 48, more specifically a large contact surface. The cross member 46 should be configured in the same way.

The German Patent Application “Stirrup Insert for a Stirrup” of the applicant, filed on the same priority date, describes in detail the configuration of the rubber insert 50 as it is seen in the FIGS. 1 through 3. The disclosure of this application is fully incorporated herein by reference.

1-8. (canceled)

9. An articulated stirrup comprising a footplate and a U-shaped clamp, said clamp having two lateral limbs, an articulated region arranged in each of said lateral limbs, said articulated regions comprising an upper retaining part, a lower retaining part, and a hinge part arranged between said two retaining parts, said lower retaining part projecting into said footplate, said footplate comprising a carrier part and a body part, said carrier part being disposed inside in said body part and that said carrier part joins said lower retaining parts together.

10. The articulated stirrup of claim 9 wherein said carrier part is made from a material that has a tensile strength.

11. The articulated stirrup of claim 9 wherein said carrier part is connected to said lower retaining parts by means of a shape-mating connection.

12. The articulated stirrup of claim 11 wherein said shape-mating connection is an integral connection.

13. The articulated connection of claim 11 wherein said shape-mating connection is a permanent connection.

14. The articulated stirrup of claim 9, wherein said carrier part comprises a rough surface.

15. The articulated stirrup of claim 9 wherein said body is made by casting.

16. The articulated stirrup of claim 9 wherein said carrier part has two lower retaining parts integrally joined together by said carrier part.

17. The articulated stirrup of claim 9 wherein said carrier part meets the static and dynamic demands required for said footplate.

18. The articulated stirrup of claim 9 wherein said shaped clamp has a substantially metallic surface.

19. The articulated stirrup of claim 9 wherein said hinge part arranged between said two retaining parts comprises a piece of a bicycle chain.

20. The articulated stirrup of claim 9 wherein said carrier part is selected from the group consisting of a piece of rope, a chain, a plate, a cast part and a profile.

21. The articulated stirrup of claim 18 wherein said carrier part comprises a rough surface and recesses.

22. The articulated stirrup of claim 9 wherein said carrier part comprises recesses into which plastic material incorporates during formation of said plastic body.
